(19) United States
(12) Patent Application Publication
(10) Pub. No.: US 2017/0201428 A1
(43) Pub. Date: Jul. 13, 2017

(54) Interactive Graphical User Interface (GUI) for Managing Sites

(71) Applicant: CA, Inc., New York, NY (US)

(72) Inventor: Jason Normandin, Marlborough, MA (US)

(21) Appl. No.: 14/994,539

(22) Filed: Jan. 13, 2016

(51) Int. Cl. H04L 12/24; H04W 4/02; G06F 7/08; G06T 11/40; G06T 11/00; G06F 3/0484; G06Q 10/06; H04L 12/26

(52) U.S. Cl. CPC H04L 41/5003; G06Q 10/0639; H04L 41/22; H04L 41/14; H04W 4/025; H04L 43/04; G06T 11/40; G06T 11/001; G06F 3/04842; G06F 3/04845; G06F 7/08; G06F 2203/04806

(57) ABSTRACT

A control computer allows users to determine various resource-related aspects of complex network systems separated over a wide geographical area. The control computer generates interactive graphical indicators for each of one or more sites, and displays those indicators on geographical maps to identify the locations of those sites. The graphical indicators also visually represent a current availability of the resources at the sites, as well as the current use, and/or the potential for the use, of those resources at the sites. Thus, a user viewing the graphical indicators can easily determine the current health and performance of a site simply by visually inspecting its corresponding graphical indicator.

### BACKGROUND

The present disclosure relates to performance management for communications systems, and more particularly to computing devices that facilitate an operator's ability to manage various sites in a communications system.

Many organizations have or operate complex networked communications systems distributed across large geographical areas. These systems are generally defined by various sites, with each site comprising multiple different devices. Such devices include, but are not limited to, routing devices, computer servers, switching devices, gateway devices, access points, transceiver devices, and the like. Regardless of the particular device, however, the devices at each site are generally associated with a fixed set of resources (e.g., bandwidth) and are subject to predetermined constraints memorialized in a set of one or more agreements (e.g., Service Level Agreements—SLA).

The operators and administrators of such sites usually need to view and to understand the health and performance of these sites, both individually and collectively, with respect to the resources and constraints of the sites. The operators also need to identify actual or potential issues with one or more of their sites, as well as to project and understand the potential capacity of one or more sites to handle a given load.

### BRIEF SUMMARY

Embodiments of the present disclosure provide an easy, intuitive manner in which to determine the various resource-related aspects of complex computer network sites that are separated over a wide geographical area. More particularly, embodiments of the present disclosure collect data from the network sites related to the availability and usage of various resources by the devices at the network sites. Based on an analysis of the collected data, graphical indicators are generated and overlaid onto a map that is displayed as part of an interactive graphical user interface (GUI). Each graphical indicator corresponds to a particular site or site(s), and identifies the current capacity of the resources at the site(s), as well as the use of those resources at the site(s). Thus, simply by viewing the graphical indicators on the interactive map, operators are able to accurately determine the health and performance of the sites as it relates to resource usage and availability.

Accordingly, one embodiment of the present disclosure provides a method for determining the various resource-related aspects of complex computer network sites. The method is implemented at a monitoring computer, and comprises receiving performance data for plurality of sites, wherein the performance data comprises metrics data indicating aggregated resource usage at the plurality of sites relative to an aggregated amount of resources available at the plurality of sites, generating an interactive indicator for the plurality of sites based on the performance data, wherein the indicator comprises first and second concentric objects representing the aggregated resource usage at the plurality of sites relative to the aggregated amount of resources available at the plurality of sites, respectively, generating an interactive graphical user interface (GUI) comprising a map encompassing a geographical area in which the plurality of sites are located, overlaying the indicator on the GUI so as to identify the geographical area in which the plurality of sites are located, and outputting the interactive GUI to a display device.

In another embodiment, the present disclosure provides a corresponding computing device comprising a communications interface circuit and a processing circuit. The communications interface circuit is configured to receive performance data for plurality of sites, wherein the performance data comprises metrics data indicating aggregated resource usage at the plurality of sites relative to an aggregated amount of resources available at the plurality of sites. The processing circuit, which is communicatively connected to the communications interface circuit, is configured to generate an interactive indicator for the plurality of sites based on the performance data, wherein the indicator comprises first and second concentric objects representing the aggregated resource usage at the plurality of sites relative to the aggregated amount of resources available at the plurality of sites, respectively, generate an interactive graphical user interface (GUI) comprising a map encompassing a geographical area in which the plurality of sites are located, overlay the indicator on the GUI so as to identify the geographical area in which the plurality of sites are located, and output the interactive GUI to a display device.

In another embodiment, the present disclosure provides a corresponding computer-readable storage medium comprising computer code stored thereon, which when executed by a processing circuit of a computing device, controls the computing device to receive performance data for plurality of sites, wherein the performance data comprises metrics data indicating aggregated resource usage at the plurality of sites relative to an aggregated amount of resources available at the plurality of sites, generate an interactive indicator for the plurality of sites based on the performance data, wherein the indicator comprises first and second concentric objects representing the aggregated resource usage at the plurality of sites relative to the aggregated amount of resources available at the plurality of sites, respectively, generate an interactive graphical user interface (GUI) comprising a map encompassing a geographical area in which the plurality of sites are located, overlay the indicator on the GUI so as to identify the geographical area in which the plurality of sites are located, and output the interactive GUI to a display device.

Of course, those skilled in the art will appreciate that the present embodiments are not limited to the above contexts or examples, and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements.

FIG. 1 is a block diagram illustrating some functional components of a computer network system configured according to one embodiment of the present disclosure.

FIG. 2 is a block diagram illustrating a map of an interactive graphical user interface (GUI) configured to display one or more graphical indicators according to embodiments of the present disclosure.

FIG. 3 is a block diagram illustrating a GUI generated to magnify a selected region illustrated in FIG. 2 according to embodiments of the present disclosure.

FIG. 4 is a block diagram illustrating a GUI generated to magnify a selected area of the region illustrated in FIG. 3 according to embodiments of the present disclosure.

FIG. 5 is a flow diagram illustrating a method for generating the interactive GUI according to embodiments of the present disclosure.

FIG. 6 is a flow diagram illustrating a method for zooming in on a selected geographical area (i.e., increasing a scale of a selected geographical area) comprising one or more sites according to embodiments of the present disclosure.

FIG. 7 is a flow diagram illustrating a method for detecting and addressing resource-related anomalies according to embodiments of the present disclosure.

FIG. 8 is a functional block diagram illustrating some functional components of a control computer configured according to one embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded on to a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Accordingly, embodiments of the present disclosure provide operators with an easy, intuitive manner in which to determine the various resource aspects of complex computer network sites that are separated over a wide geographical area. More particularly, a control computer collects and analyzes information related to the availability and usage of various resources by one or more devices at one or more sites. Based on the analysis, the control computer generates and displays graphical indicators for output on to an interactive geographical map that is displayed to an operator. Each graphical indicator corresponds to a particular site or site(s), and identifies the current capacity of the resources (e.g., bandwidth, capacity, etc.) at the site(s), as well as the use of those resources at the site(s). Thus, merely by viewing the interactive map, the operator is able to accurately determine the health and performance of one or more sites as it relates to resource usage and availability. In some embodiments, the control computer can also project the future health and performance of the sites being monitored based on the collected information.

Additionally, the central computer can autonomously recognize potentially problematic conditions at the different sites for the operator (e.g., low bandwidth or overload issues), and in response, recommend various actions to be taken by the operator, or initiate those actions, to relieve or avoid the detected conditions. For example, the control computer may recommend increasing the number of devices at a site to increase available bandwidth, reduce the number of devices at sites that are not very busy, reallocate the resources associated with one or more devices between different sites so as to balance a load, and the like. Of course, these particular actions are merely illustrative. Other actions may be recommended and/or initiated by the central computer as needed or desired.

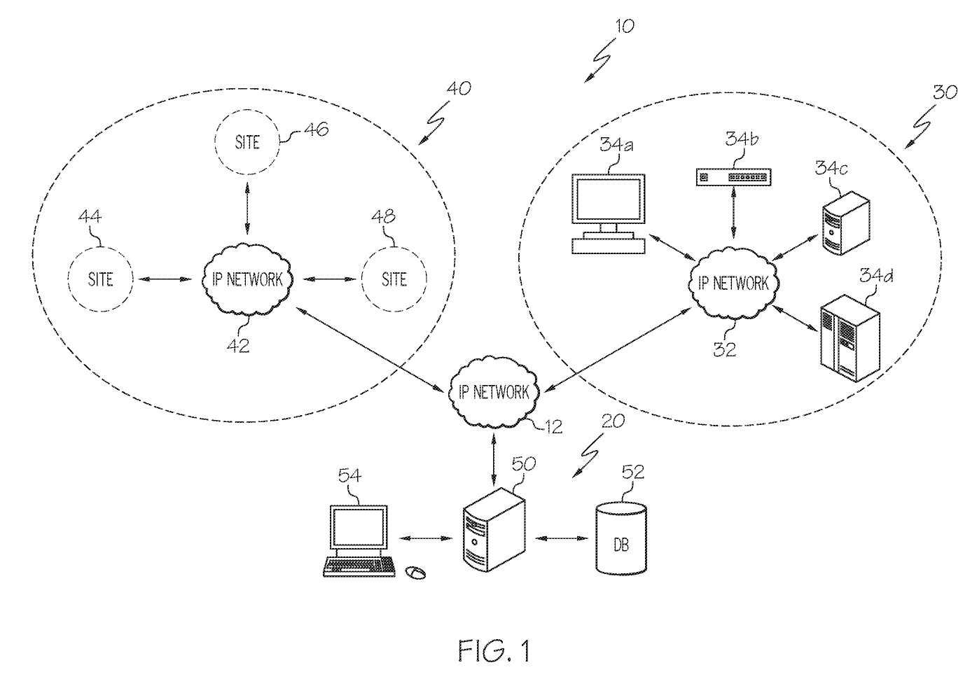

Turning now to the drawings, FIG. 1 is a block diagram illustrating some of the components comprising a system 10 configured according to the present disclosure. Those of ordinary skill in the art will appreciate that the various components seen in FIG. 1 are illustrative only, and that more components, fewer components, and different components may be present as needed or desired.

System 10 comprise a communications network 12 that communicatively connects a control location 20 to one or more remote “sites” 30, 40. As used herein, a “site” may be, for example, a geographical area such as a city, a region, a building, or a campus, for example, which is associated with one or more devices to be monitored. Further, a given site may be an individual site that has one or more devices, but may also be an aggregate individual sites that have one or more devices. For example, a site representing the east coast of the United States may comprise one or more regional sites (e.g., Northeast, Mid-Atlantic, South-East, etc.). Each of these regional sites may further comprise one or more sites associated with cities in the region (e.g., Framingham site, Boston site, Portland site, etc.). Similarly, the sites associated with the different cities may encompass one or more other sites such as buildings or campuses, etc. However, regardless of whether a given site is an individual site or an aggregation of individual sites, all sites are associated with one or more pieces of equipment that are monitored by a control server 50 at control location 20 in order to determine the health and performance of that site.

Site 30 is illustrative of a single site that may represent the various devices at a building or campus. As seen in FIG. 1, site 30 comprises an IP network 32 and a plurality of various devices 34a, 34b, 34c, 34d (collectively devices 34). The IP network 32 is similar to IP network 12 in that both networks generally comprise any number of public and/or private communications networks suitable for communicating data in packets between site 30 and control location 20. Such networks may include, but are not limited to, the Internet, and may comprise any type of wireline and/or wireless network known in the art.

According to the present disclosure, devices 34 may comprise any hardware device, and/or software function executing on a hardware device, whose performance can be monitored by the control computer 50. In the embodiment of FIG. 1, for example, devices 34 include a computing device (e.g., a user terminal) 34a, a router 34b, an application server (AS) 34c, and an air conditioner 34d. Those of ordinary skill in the art should appreciate, however, that neither the particular types of devices 34 monitored in system 10, nor their specific functions, are germane to the present embodiments. Rather, it is sufficient to know that devices 34, and others like them, provide data related to their performance to control computer 50 via networks 12, 32. Such data may be provided by each device 34 in response to an explicit request for the data made by control computer 50, and/or in response to some predefined trigger event detected by device 34, and/or autonomously by each device 34 to control computer 50 at periodic intervals. Regardless of what type of data is provided, however, the data sent by devices 34 may include, but is not limited to, data indicative of a bandwidth usage, error rate, discard rate, operating temperature, operating mode, and the like.

As stated above, sites configured according to the present embodiments need not be individual sites, such as site 30. In some embodiments, a site may comprise an aggregation of a plurality of individual sites 30, and/or of other aggregated sites which themselves include a plurality of individual sites 30. Regardless of the particular hierarchy of a given site, however, the devices associated with each site in an aggregated site are still monitored by, and provide performance metrics to, the control computer 50—even though the individual sites may be geographically separated by appreciable distances. Further, as explained in more detail below, the performance metrics they provide are aggregated and organized as if the those metrics originated from a single site.

For example, site 40 is illustrative of one such “aggregated site” according to the present disclosure. More particularly, site 40 comprises one or more IP networks 42, which are similar in functionality to networks 12 and 32 above, and one or more constituent sites 44, 46, and 48. One or more of the sites 44, 46, 48, may itself comprise an individual site, such as site 30 having devices 34, or may comprise another aggregated site having a plurality of such individual sites 30. Thus, sites such as site 40 may comprise a hierarchy of one or more other sites.

As stated previously, the control location 20 is a control center or central site, for example, configured to monitor the performance of the various devices associated with the different sites by collecting and analyzing performance metric data sent by the devices at each of the sites. To that end, this embodiment of control location 20 comprises a control computer 50 connected to a computer readable storage medium (DB) 52 and a user terminal 54.

The control computer 50, as will be described in more detail later, is a specially configured computing device that monitors the devices (e.g., devices 34) at the various sites 30, 40, to obtain their performance data, and to organize that performance data for output to terminal 54 for a user. More particularly, the control computer 50 is configured to analyze the performance data received from the devices at sites 30, 40, and store that data in DB 52. Then, based on the analysis, control computer 50 is configured to generate an interactive Graphical User Interface (GUI) for output to terminal 54. The GUI, as seen in more detail below, provides an intuitive geographic location-based layout of each site 30, 40 so that a user can determine the collective performance “health” of the devices at the respective sites simply by viewing the GUI.

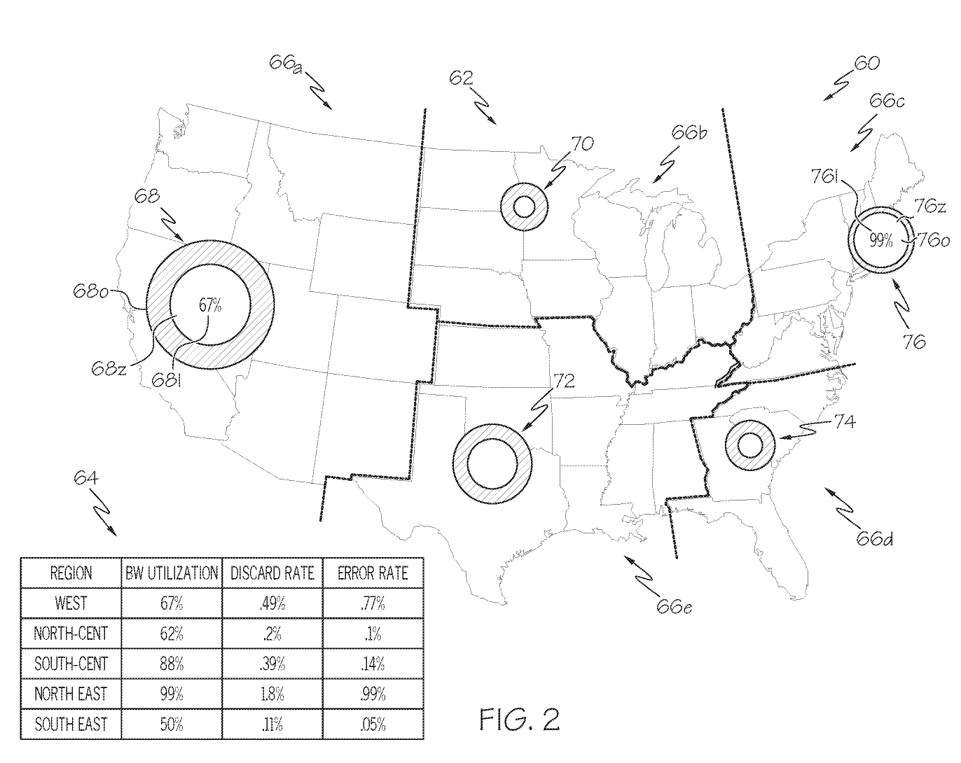

FIG. 2 is a perspective view of one such GUI 60 that may be generated by control computer 50 and displayed to a user. As seen in FIG. 2, GUI 60 is generated to comprise a map 62 and a table 64. The map 62 in this embodiment is a map of the United States. However, as those of ordinary skill in the art will appreciate, the present disclosure is not so limited. Control computer 50 may generate maps of other geographical areas in addition to, or in lieu of, map 62 as needed or desired.

In this embodiment, map 62 is partitioned into five (5) regions 66a-66e (collectively region 66). Each region 66 comprises a corresponding graphical indicator 68, 70, 72, 74, 76 that represents the performance of one or more sites 30, 40. For example, in this embodiment, graphical indicator 68 visually represents the performance of the devices in all sites 30, 40 geographically located within region 66a (i.e., the Western region). Similarly, graphical indicator 76 represents the performance of the devices in all sites geographically located within region 66c (i.e., the Northeast region). Regardless of the particular area or site(s) they represent, however, each graphical indicator 68, 70, 72, 74, 76 is generated and displayed by control computer 50 specifically to convey the performance health of the site(s) 30, 40 within its associated region 66.

To that end, one embodiment of the present disclosure generates the graphical indicators 68, 70, 72, 74, 76 as interactive concentric objects. Using graphical indicator 68 as an example, it is generated as concentric circles comprising an inner circle 68_{I} and an outer circle 68_{O}. Each circle 68_{I}, 68_{O} represents information that is relative to the information represented in the other circle 68_{I}, 68_{O}. For example, in this embodiment, graphical indicator 68 is generated, based on the previously described analysis of the performance metrics, to convey bandwidth information associated with the corresponding sites 30, 40 located within the Western region 66a. Thus, outer circle 68_{O} represents a total amount of bandwidth available to all the sites 30, 40 in the Western region 66a, while the inner circle 68_{I} represents the actual amount of bandwidth that is being used by the devices at all the sites 30, 40 in the Western region 66a.

Further, the control computer 50 may be configured to generate each concentric circle 68_{I}, 68_{O} such that their respective sizes convey the bandwidth-related data for the sites 30, 40 to the user. For example, control computer 50 may generate the outer circle 68_{O} such that its size conveys the amount of bandwidth available to the sites 30, 40 in the Western region 66a. The more bandwidth that is available, the larger the size of the outer circle 68_{O}. Similarly, control computer 50 could generate the inner circle 68_{I} such that its size conveys the amount of bandwidth that is actually being used by the sites 30, 40 in the Western region 66a. Thus, the more bandwidth that is being used by the devices at sites 30, 40, the bigger the inner circle 68_{I} will appear on GUI 60.

So sized, the user could determine a relationship between the amount of bandwidth used at the sites 30, 40 in the Western region 66a to the amount of bandwidth that is available to the sites 30, 40 in the Western region simply by visually comparing the sizes of the inner and outer circles 68_{I}, 68_{O} of graphical indicator 68. That is, if the circles 68_{I}, 68_{O} are close in size, it may indicate that almost all of the bandwidth available to the sites 30, 40 in the Western region 66a is being used. Conversely, if inner circle 68_{I} is much smaller than the outer circle 68_{O}, then it would indicate that perhaps much of the bandwidth available to the sites 30, 40 in the Western region 66a is not being used.

In addition to the sizes of the inner and outer circles of the graphical indicators 68, 70, 72, 74, 76, the present embodiments may also utilize other graphical signs or indicators to help a user easily identify a relationship between bandwidth availability and bandwidth usage. For example, the table 64 that appears on GUI 60 provides the user with the data in an easy-to-interpret tabular format. In another example, referring back to graphical indicator 68, the control computer 50 may generate and display an informational label 68_{L} identifying the actual amount of bandwidth used by the devices at sites 30, 40 in the Western region 66a as a percentage. Using this label, the user could easily determine the amount of bandwidth used by the sites 30, 40 relative to the amount of bandwidth available to sites 30, 40.

In some embodiments, the present disclosure also utilizes predefined colors to convey information. For example, in one embodiment, the outer circles of each graphical indicator 68, 70, 72, 74, 76 may be given the color blue or some other color to uniformly identify the outer circles as conveying information related to the total amount of bandwidth available to the devices at sites 30, 40 in the corresponding region 66. Similarly, the inner circles of the graphical indicators 68, 70, 72, 74, 76 may be generated to have another color that indicates the actual amount of bandwidth used by the devices at sites 30, 40 in their corresponding regions 66. For example, inner circles that are colored green may indicate that no problems exist with respect to bandwidth utilization in that region 66. Inner circles that are colored yellow may indicate that the bandwidth usage in the region 66 is approaching some predefined threshold level that is considered too high. Inner circles that are colored red may indicate that the bandwidth usage in the region 66 has exceeded a predefined maximum threshold level, and thus, network issues such as congestion, latency, dropped packets, and the like, may exist.

It should be noted that, in at least one embodiment, filling the graphical indicators 68, 70, 72, 74, 76 with a particular color (i.e., a “fill color”) is performed independently from generating the graphical indicators 68, 70, 72, 74, 76 to be of a particular size. That is, the graphical indicators 68, 70, 72, 74, 76 may be generated and displayed on GUI 60 based on the collected metrics, as previously described, such that the relative sizes of the inner and outer circles convey information regarding the amount of resources used relative to the amount of resources that are available. Independently from generating the inner and outer circles to have their corresponding sizes, however, embodiments of the present disclosure may also generate one or both of the inner and outer circles to comprise a particular fill color. The color, as stated above, may convey certain information about the amount of resources used relative to the amount of resources that are available. However, the fill color that is selected and used to fill a given inner and/or outer circle need not be based on the relative size(s) of the inner and/or outer circles.

Of course, whether a given inner circle is red, yellow, or green (or any other color) may be defined by the user. For example, the performance metrics collected from the devices at sites 30, 40 may be compared against a set of predetermined user-specified threshold values that are stored in a profile accessible to control computer 50. Based on the results of the comparison, the inner circles could be generated to have a corresponding color. This would allow the user to instantly identify those sites 30, 40 that have a problem with bandwidth.

Knowing that a problem might exist with a given site 30, 40 using a simple visual inspection of graphical indicators 68, 70, 72, 74, 76 is beneficial for the user. Particularly, it allows the user to focus his/her attention on the sites and/or devices that could be (or are) problematic in order to definitively define the problem and/or a resolution.

For example, consider graphical indicator 76 of FIG. 2 which represents all the sites 30, 40 in the Northeastern region 66c. As seen in FIG. 2, the inner circle 76_{I} is almost the same size as the outer circle 76_{O}. Additionally, both the label 76_{L} and the information contained in table 64 indicate that most of the bandwidth is being used. Further, the inner circle 76_{I} is red, thereby indicating that the bandwidth usage in region 66c is at, or near, its maximum capacity.

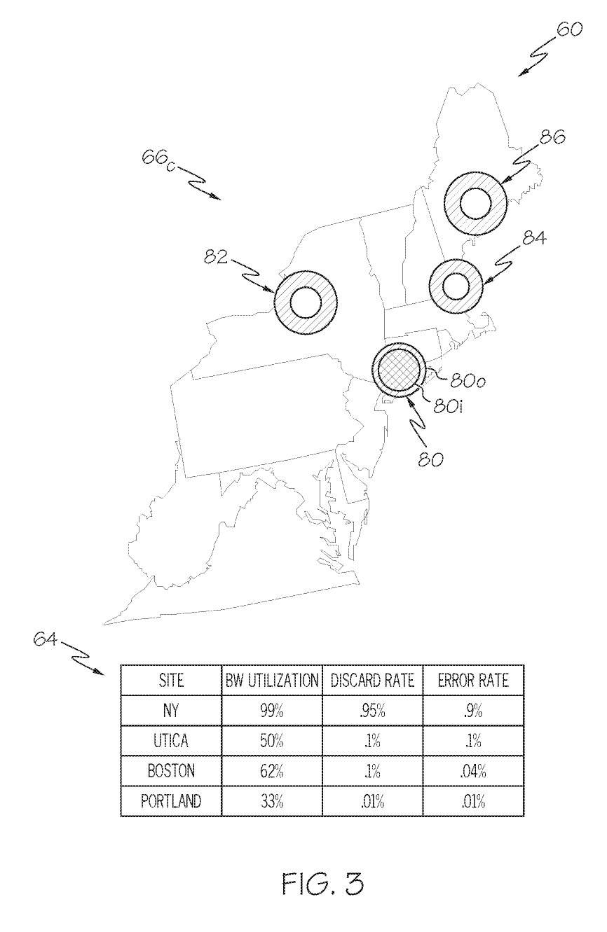

As stated above, the graphical indicators 68, 70, 72, 74, 76 are interactive. Thus, to further investigate any possible bandwidth-related issues in region 66c, the user simply selects or “clicks” (e.g., double-clicks) on the graphical indicator 76. This action (or some other action performed by the user) causes control computer 50 to increase a scale of (i.e., “zoom-in” on) region 66c, as seen in FIG. 3. Particularly, control computer 50 generates the map of region 66c, and overlays a new graphical indicator 80, 82, 84, 86 to indicate the geographical locations of each of the sites 30, 40 that are within the selected Northeastern region 66c.

As above, each graphical indicator 80, 82, 84, 86 comprises an interactive icon having concentric inner and outer circles. The outer circle (e.g., outer circle 80_{O}) represents the total amount of bandwidth that is available at a site, while the inner circle (e.g., inner circle 80_{I}) indicates the actual amount of bandwidth that is utilized at the site. The graphical indicators may also comprise labels (e.g., label 80_{L}) that convey the amount of bandwidth used at a site 30, 40 as a percentage relative to the total amount of bandwidth available to the site 30, 40. Further, the color scheme and relative sizes of the generated inner and outer circles are similar to those discussed above, and the information in table 64 is updated to correspond to the information provided by each of the sites identified by the graphical indicators 80, 82, 84, 86. Thus, even though the GUI 60 presents a more “magnified” (i.e., “zoomed-in”) geographical area (i.e., the sites 30, 40 within the Northeastern region 66c), the user is better able to determine which of those particular sites 30, 40 may be the cause of a current or potential problem.

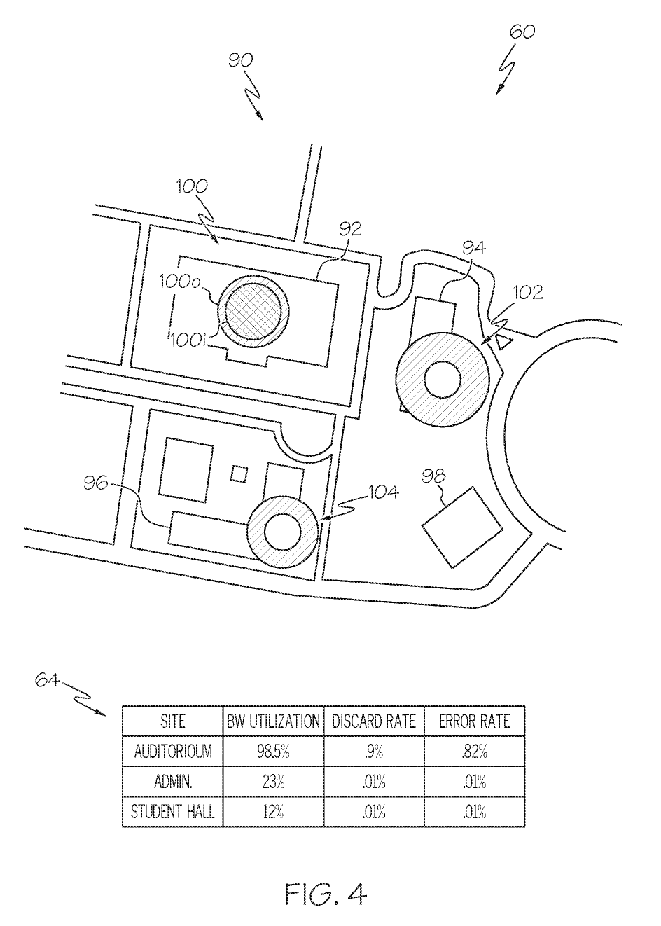

Therefore, selecting the graphical indicator 80 in this embodiment causes control computer 50 to alter GUI 60 to increase the scale of (i.e., “zoom-in” on) the particular site 30, 40 represented by that graphical indicator 80. As seen in FIG. 4, the site 30, 40 represented by graphical indicator 80 is a campus 90 having a plurality of buildings 92, 94, 96, 98. Some of the buildings (i.e., buildings 92, 94, 96) have one or more of the devices 34 previously described operating therein. In a manner similar to that of FIG. 3, the control computer 50 generates the various graphical indicators 100, 102, 104 for GUI 60 based on the metrics information collected for the devices 34 in the buildings, positions each graphical indicator 100, 102, 104 relative to its geographical location (i.e., its particular building), and updates the information in table 64 to reflect the latest collected performance metrics for each site represented by a graphical indicator 100, 102, 104. As above, the relative sizes of the inner and outer circles (e.g., inner circle 100_{I} and outer circle 100_{O}), as well as their respective colors, convey information related to the bandwidth resources, the priority of the sites, and/or other resource aspects, as previously stated.

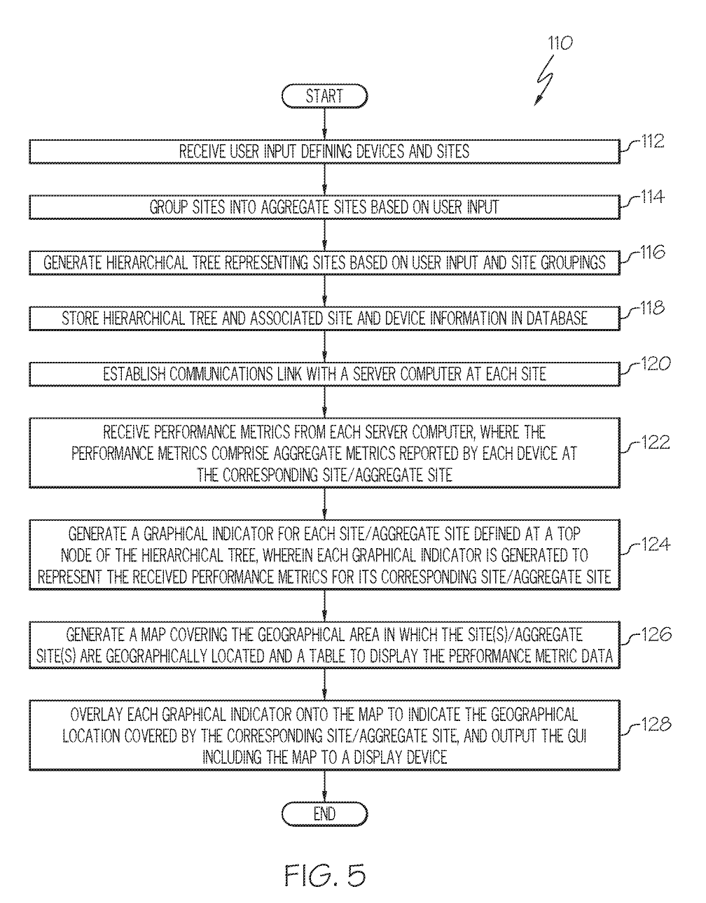

FIG. 5 is a flow diagram illustrating a method 110 for generating and overlaying the graphical indicators on a map for display to a user on GUI 60. It should be noted that, in the embodiment of FIG. 5, the steps of method 110 are performed at the central computer 50.

Method 110 begins with the control computer 50 receiving user input from terminal 54 defining the various devices 34 and sites 30 in the system 10 (box 112). The user may enter this information as text, or alternatively, select the device and site information from one or more drop down lists or other GUI controls, as is known in the art. Regardless, however, the information provided by the user may include such data as a unique name/ID for a device or site, which site each device belongs to, geographical location information associated with the site and/or device, whether the control computer 50 should poll the device (or another computer) for the performance metrics related to the device or site, how often such polling should occur (if at all), contact information that identifies where to send alert notifications related to a detected anomaly with the device or site, data related to historical resolutions for particular anomalies (e.g., a link to a knowledgebase), and the like. Of course, any information needed or desired may be provided by the user; however, according to the present disclosure, the information provided by the user is utilized to generate the maps covering the geographical area of the sites, the graphical indicators that are overlaid on those maps, data for the table 64, and the like.

Once the user has defined the devices and corresponding sites, control computer 50 will group the various sites 30 defined by the user into one or more aggregate sites 40 (box 114). Such groupings may be based on any criteria known in the art, but in accordance with one embodiment, the control computer 50 groups the sites 30 based on the geographical location of the sites 30.

For example, in one embodiment, the control computer 50 automatically groups the various sites 30, 40 based on a Common Language Location Identifier (CLLI) Code. As is known in the art, a CLLI Code may be formatted according to any of at least four known formats—the Network Site Code Format, the Network Entity Code Format, the Network Support Site Code Format, and the Customer Site Code Format. Regardless of the particular format, however, the CLLI Code comprises a multi-character code. With some CLLI Code formats, the first four characters (i.e., referred to as the Geographical Element) indicate the geographical area for the equipment at a given site (e.g., city, town, borough, etc.), while the next two characters (i.e., referred to as the Geopolitical Code Element) indicate the geopolitical location of the equipment at a site (e.g., state, province, country, etc.). In other CLLI formats, the first eight characters are utilized to indicate such information. However, depending on the format, the remaining characters in a CLLI Code may comprise, for example, a building identifier that identifies a particular building in which the equipment is located, a non-building location identifier that identifies a location for the equipment that is not a building, a site indicator and a function for the equipment.

According to embodiments of the disclosure, the CLLI code may be received at the central computer 50 when the sites 30, 40 report their metrics. Upon receipt, the control computer 50 parses the CLLI Code to extract the information needed to identify the corresponding location. Based on those character values, the control computer 50 could determine the particular geographical location—including in some cases a building—for the equipment at each site, and then use that information to group the different sites 30, 40 that report metrics.

Additionally, or alternatively, embodiments of the present disclosure may utilize other criteria for determining these groupings. For example, the control computer 50 may select a particular site based on priority, and then group all other sites 30 that are within a predefined distance of the selected site into a single aggregate site 40. Of course, in some embodiments, a user at terminal 54, for example, can manually define the groupings, or alternatively, manually alter the groupings that have been automatically generated by the control computer 50.

The control computer 50 then generates a computer model from this information to represent the devices, the sites, and the site groupings for use in generating the various maps and graphical indicators. In one embodiment, for example, the control computer 50 generates a hierarchical tree representing the sites (box 116), and then stores the tree, along with related information and data, into the database 52 (box 118). In this embodiment, the root node of the tree represents the largest geographical region, and thus, the largest grouping of sites. Each leaf node therefore represents a more “magnified” part of that geographical region, and thus, the various sites that comprise that grouping. Accordingly, when presented with GUI 60, the user may see a first graphical indicator for all sites in North America that indicates the health and performance of all sites in North America. Upon selecting that North American site indicator, the user might see one or more (possibly aggregate) graphical site indicators representing the health and performance of one or more of the regional sites, such as the previously described regions 66. The user may continue to select graphical indicators representing the sub-regions or other sites, and thus, progressively “drill down” into (i.e., magnify) one or more desired sites to quickly assess the health and performance of those sites.

The control computer 50 can then utilize information provided by the user to establish one or more communications links (box 120) over which it will receive the performance metrics (box 122). In one embodiment, some sites have a specially configured computer server that collects and aggregates the performance data from the devices at the site before sending that data on to the control computer 50. Where aggregate sites are concerned, one of the specially configured computer servers may also be responsible for collecting the aggregated data from each individual server, before aggregating that data to send on to the control computer 50. In some cases, the control computer 50 may collect the performance data from the individual devices. However, regardless of how the data is received at control computer 50, the data is aggregated for all sites in a hierarchical manner that mirrors the nodes of the hierarchical tree.

From the received performance metrics, control computer 50 generates a graphical indicator for each site to visually convey information about the resources at that site (box 124). In one embodiment, for example, the control computer 50 generates a graphical indicator for each node in the hierarchical tree based on the performance metrics for the sites in that node. Then, the control computer 50 generates a map 62 that covers the geographical area in which the sites are located (box 126). As previously stated, the map generated for the root node would cover a larger geographical area than would any of its child nodes, which would cover a smaller, more magnified geographical area.

Control computer 50 then overlays the graphical indicators on to the generated map such that their position on the map reflects their actual geographical locations, and outputs the map with the GUI 60 to a display device for display to the user (box 128). In one embodiment, for example, the control computer 50 outputs the GUI 60 to the user terminal 54, which upon receipt, displays the GUI 60, including the map and the graphical indicators, on its corresponding display device.

As stated above, the user can control the visual representation of the graphical indicators displayed on the map. For example, one embodiment uses concentric circles to designate various sites, with the sizes of the circle representing the importance of a given site. Larger circles may equate to very important sites, while smaller circles may equate to less important sites. Additionally, the color of any given circle may be altered to indicate health or current performance of the site. By way of example only, red may be used to indicate that resource utilization as exceeded a predefined limit, while green may indicate resource utilization is within expected parameters. Other colors, such as orange or yellow, for example, may be used to indicate that while a given site has not yet exceeded a predefined limit, it is approaching that predefined limit, and therefore, may warrant attention.

As previously described, the control computer 50 may also update the summary information in table 64 to indicate the health of the site upon user selection of a site. Alternatively, or additionally, such tables could be generated by the control computer 50 and displayed to the user responsive to the control computer 50 detecting a mouse pointer hovering over a given graphical indicator. In these latter cases, the table 64 would be updated to reflect the performance metric data associated with that graphical indicator.

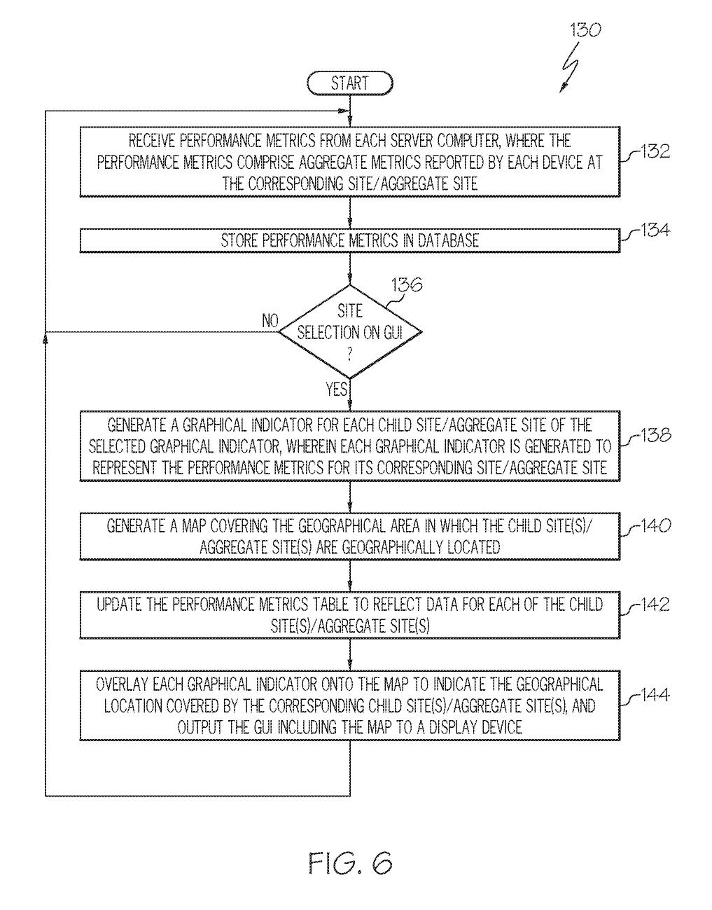

FIG. 6 is a flow diagram illustrating a method 130 in which the user can focus on more specific geographical areas of map 62 and the sites that are covered by that magnified area. Method 130 is also performed at the control computer 50, and assumes that GUI 60 is displayed at the user terminal 60 showing the map 62 and the sites/aggregated sites that are associated with a top node of the hierarchical tree.

As seen in FIG. 6, method 130 begins with the control computer 50 receiving the performance metrics from the specially configured computer server(s) (box 132). As previously described, the performance metrics may be aggregated and stored in the database 52 (box 134). When the control computer 50 detects that a user has selected a graphical indicator representing a site (box 136), control computer 50 will perform the steps necessary for increasing the scale of (i.e., “zooming-in” on) the geographical area corresponding to the selected indicator producing a magnified geographical area for display to the user. Particularly, in this embodiment, control computer 50 generates a graphical indicator for each child site/aggregate site defined by the immediate child nodes in the hierarchical tree (box 138). As above, each graphical indicator comprises concentric circles and is generated such that the size, color(s), and/or other aspects of the circles visually convey information related to resource usage at the site. Control computer 50 then generates a map that covers the geographical area in which only the child sites are located (box 140), updates the information in the table 64 with the performance metrics data for each child site (box 142), and overlays the graphical indicators on the map at positions that reflect their actual geographical locations (box 144) before outputting the GUI 60 including the map and graphical indicators to the user terminal 54 for display to the user. This process of “zooming-in” on a geographical area that includes one or more sites, as seen in FIG. 6, may continue so long as there are child nodes in the hierarchical tree that define another site.

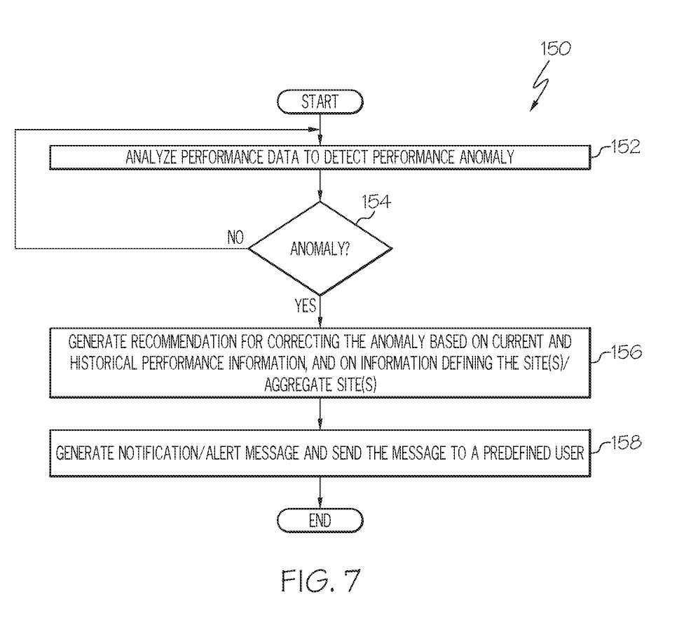

In addition, the present disclosure also provides an embodiment, shown in FIG. 7, in which the control computer 50 can autonomously detect an anomaly related to resource usage at a site, and either automatically perform the steps necessary to correct the problem or generate an alert message to notify the user of the problem.

As seen in FIG. 7, method 150 begins with the control computer 50 analyzing the performance metrics received from the computer servers at each of the sites (box 152). Such an analysis may be performed, for example, upon receipt of the performance metric from the computer servers, and/or periodically (e.g., every hour), and/or upon detection of the occurrence of a predefined trigger event (e.g., devices and/or sites are added or removed). It should be noted, however, that the user may define how often such an analysis is performed, as well as what specific triggers will cause the control computer 50 to perform the analysis.

Regardless of when the analysis is performed, however, the control computer 50 is configured to perform one or more actions upon detecting an anomaly with the performance metrics data (box 154). By way of example only, the control computer 50 may detect whenever a particular performance metric value exceeds a predetermined threshold (e.g., whenever a bandwidth usage metric for a given device exceeds a first predefined threshold value). Upon detecting the condition, the control computer 50 may access historical resolution information stored in a knowledge base, for example, in order to locate a possible solution to the problem (box 156). Such access may be based, for example, on the identity or type of device related to the anomaly, as well as other information as needed or desired. Once a candidate solution is found, if one is found at all, the control computer 50 can, in some cases, autonomously implement the solution in an attempt to correct the issue. Alternatively, or additionally, the control computer 50 may generate and send a notification message to a predefined user to alert that user to the condition (box 158). So informed, the user would then be able to utilize GUI 60 and the previously described embodiments to determine the source or cause of the problem and possibly fix the problem.

For example, the control computer 50 may detect that a given site is nearing, or has exceeded, a bandwidth threshold. Based on this detection, the control computer 50 might determine that a capacity issue exists at a particular site, and in response, change the color of the inner circle associated with the site from green or yellow, for example, to red. Additionally, control computer 50 may generate and send a notification message to a user identifying the issue recommending that the bandwidth be increased at that particular site. Such recommendations may comprise, for example, the control computer 50 sending a message to a user identifying specific devices at the same or different sites for reconfiguration to increase the available bandwidth. Alternatively, the control computer 50 may automatically reconfigure such devices using configuration information for the device stored at the database 52, or perform such functions responsive to a user command.

Those of ordinary skill in the art will appreciate, however, that the present embodiments are not limited to performing actions that increase bandwidth. In another embodiment, the control computer 50 is configured to detect when a given device or site is below a predefined bandwidth threshold. In these cases, the control computer 50, or the user in response to a notification message sent by the control computer 50, can perform one or more actions that decrease the amount of bandwidth at a site. As above, control computer 50 can alter the appearance of the concentric objects on the GUI 60 to indicate the detected issue to the user.

The previous embodiments describe the present disclosure in terms of bandwidth usage, and more specifically, the amount of bandwidth used at a given site relative to the amount of bandwidth available at the given site. However, those of ordinary skill in the art will readily appreciate that the embodiments of the present disclosure are not so limited.

For example, in another embodiment, the control computer 50 generates the graphical indicators to convey the relationship between a total amount of bandwidth available at a site and a total number of errors detected at the given site. In this case, the outer concentric circle may be generated, and color-coded, to convey the total amount of available bandwidth while the inner concentric circle may be generated, and color-coded, to convey the total number of errors detected at the site. Such errors may be, for example, transmission errors or any other error at a device or site that is detectable and reportable in the performance metrics.

Other relationships that may be visually depicted using the graphical indicators on GUI 60 include a relationship between a Quality of Service (QoS) level agreed to in a Service Level Agreement (SLA) and an actual amount of uptime (or downtime), a relationship between a total desired capacity and an actual capacity, and any other relationship that can be visually depicted by generating and displaying the concentric objects on GUI 60 according to the present disclosure.

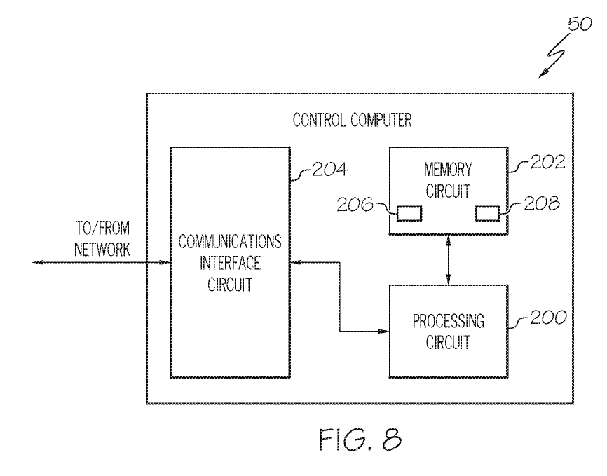

FIG. 8 is a functional block diagram illustrating some components of an exemplary control computer 50 configured to operate according to one or more embodiments. As seen in FIG. 8, control computer 50 comprises a programmable processing circuit 200, a memory circuit 202, and a communications interface circuit 204. The processing circuit 200 may be implemented by one or more microprocessors, hardware, firmware, or a combination thereof, and generally controls the operation and functions of control computer 50 according to the embodiments previously described. Such operations and functions include, but are not limited to, defining the sites and their associated devices responsive to user input, receiving aggregated performance metrics related to the operation of the devices at those sites, generating GUI 60 to include one or more graphical indicators visually depicting the performance of the sites in accordance with the aggregated metrics, and generating a map to cover the geographical area in which the sites are located, as previously described.

Memory circuit 202 may comprise any non-transitory, solid state memory or computer readable media known in the art. Suitable examples of such media include, but are not limited to, ROM, DRAM, Flash, or a device capable of reading computer-readable storage media, such as optical or magnetic media. Memory circuit 202 stores a control application 206 that when executed by the processing circuit 200, controls the control computer 50 to perform the functions previously described according to embodiments of the present disclosure. In some embodiments, memory circuit 202 may also store one or more profiles 208 that store user-specified thresholds, for example, and other user-defined data.

The communications interface circuit 204 comprises a transceiver or other communications interface that facilitates the communication of data (e.g., performance metrics) with the sites 30, 40 via one or more of the IP networks 12, 32, 42, as well as with DB 52 and/or other computer-readable storage media. Additionally, the user terminal 54 can communicate commands and messages with the control computer 50 via the communications interface circuit 204. For example, as stated above, the GUI 60 and graphical indicators that are displayed to the user are communicated from the control computer 50 to the user terminal 54. Additionally, the commands provided by the user to control the control computer 50 to generate more magnified maps and their corresponding graphical indicators are received from the user terminal 54 via the communications interface circuit 204. Although the communications interface circuit 204 may communicate data according to any known protocol, the communications interface circuit 204 in one embodiment comprises an interface card that operates according to any of standards defining the well-known ETHERNET protocol.

The present embodiments may, of course, be carried out in other ways than those specifically set forth herein without departing from essential characteristics of the disclosure. For example, it should be noted that the flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, to blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method implemented at a monitoring computer, the method comprising:
receiving performance data for plurality of sites, wherein the performance data comprises metrics data indicating aggregated resource usage at the plurality of sites relative to an aggregated amount of resources available at the plurality of sites;
generating an interactive indicator for the plurality of sites based on the performance data, wherein the indicator comprises first and second concentric objects representing the aggregated resource usage at the plurality of sites relative to the aggregated amount of resources available at the plurality of sites, respectively;
generating an interactive graphical user interface (GUI) comprising a map encompassing a geographical area in which the plurality of sites are located;
overlaying the indicator on the GUI so as to identify the geographical area in which the plurality of sites are located; and
outputting the interactive GUI to a display device.

2. The method of claim 1 wherein generating the interactive indicator further comprises generating the interactive indicator based on a relative priority of a site.

3. The method of claim 1 wherein generating the interactive indicator comprises generating each of the first and second concentric objects to be respective sizes, wherein the sizes of the first and second concentric objects indicate the aggregated resource usage at the plurality of sites relative to the aggregated amount of resources available at the plurality of sites.

4. The method of claim 3 further comprising generating each of the first and second concentric objects to comprise a respective fill color independently of the respective sizes of the first and second concentric objects, wherein each fill color indicates either the aggregated resource usage at the plurality of sites or the aggregated amount of resources available at the plurality of sites.

5. The method of claim 1 further comprising:
increasing a scale of the geographical area responsive to detecting user input selecting the interactive indicator such that the map encompasses a magnified geographical area;
determining which of the plurality of sites are located within the magnified geographical area; and
for each site determined to be within the magnified geographical area:
generating an additional interactive indicator based on the performance data for the site, wherein the additional interactive indicator comprises first and second concentric objects representing the aggregated resource usage at the site relative to the amount of resources available at the site, respectively; and
overlaying the additional interactive indicator on the GUI so as to identify the geographical location of the site within the magnified geographical area.

6. The method of claim 5 wherein generating an additional interactive indicator further comprises generating the additional interactive indicator based on a priority of the site relative to a priority of another site.

7. The method of claim 6 wherein the priority of a first site is higher than the priority of a second site, and wherein generating the additional interactive indicator based on a priority of the site relative to a priority of another site comprises generating the additional interactive indicator for the first site to be larger in size than the additional interactive indicator for the second site.

8. The method of claim 5 wherein generating an additional interactive indicator based on the performance data for the site further comprises generating the interactive indicator to graphically indicate a performance of the site.

9. The method of claim 8 wherein generating the additional interactive indicator comprises color-coding the first and second concentric objects with corresponding first and second colors based on a relationship between the aggregated resource usage at the site relative to the aggregated amount of resources available at the plurality of sites.

10. The method of claim 1 further comprising grouping the each of the plurality of sites into a corresponding group based on the geographical area of each site.

11. A computing device comprising:
a communications interface circuit configured to receive performance data for plurality of sites, wherein the performance data comprises metrics data indicating aggregated resource usage at the plurality of sites relative to an aggregated amount of resources available at the plurality of sites; and
a processing circuit communicatively connected to the communications interface circuit and configured to:
generate an interactive indicator for the plurality of sites based on the performance data, wherein the indicator comprises first and second concentric objects representing the aggregated resource usage at the plurality of sites relative to the aggregated amount of resources available at the plurality of sites, respectively;
generate an interactive graphical user interface (GUI) comprising a map encompassing a geographical area in which the plurality of sites are located;
overlay the indicator on the GUI so as to identify the geographical area in which the plurality of sites are located; and
output the interactive GUI to a display device.

12. The computing device of claim 11 wherein the processing circuit is configured to generate the interactive indicator based on a priority of a site relative to a priority of another site.

13. The computing device of claim 11 wherein the processing circuit is configured to generate each of the first and second concentric objects to be respective sizes representing the aggregated resource usage at the plurality of sites relative to the aggregated amount of resources available at the plurality of sites.

14. The computing device of claim 13 wherein the processing circuit is configured to generate each of the first and second concentric objects to comprise a respective fill color independently of the respective sizes of the first and second concentric objects, wherein each fill color indicates either the aggregated resource usage at the plurality of sites or the aggregated amount of resources available at the plurality of sites.

15. The computing device of claim 11 wherein the processing circuit is further configured to:
increase a scale of the geographical area responsive to detecting user input selecting the interactive indicator such that the map encompasses a magnified geographical area;
determine which of the plurality of sites are located within the magnified geographical area; and
for each site determined to be within the magnified geographical area:
generate an additional interactive indicator based on the performance data for the site, wherein the additional interactive indicator comprises first and second concentric objects representing the aggregated resource usage at the site relative to the amount of resources available at the site, respectively; and
overlay the additional interactive indicator on the GUI so as to identify the geographical location of the site within the magnified geographical area.

16. The computing device of claim 15 wherein the processing circuit is configured to generate the additional interactive indicator based on a priority of the site relative to a priority of another site.

17. The computing device of claim 16 wherein the priority of a first site is higher than the priority of a second site, and wherein the processing circuit is further configured to generate the additional interactive indicator for the first site to be larger in size than the additional interactive indicator for the second site.

18. The computing device of claim 15 wherein the interactive indicator graphically indicates a performance of the site.

19. The computing device of claim 11 wherein the processing circuit is further configured to color-code the first and second concentric objects corresponding first and second colors based on a relationship between the aggregated resource usage at the site relative to the aggregated amount of resources available at the plurality of sites.

20. A computer-readable storage medium comprising computer code stored therein, which when executed by a processing circuit of a computing device, controls the computing device to:
receive performance data for plurality of sites, wherein the performance data comprises metrics data indicating aggregated resource usage at the plurality of sites relative to an aggregated amount of resources available at the plurality of sites;
generate an interactive indicator for the plurality of sites based on the performance data, wherein the indicator comprises first and second concentric objects representing the aggregated resource usage at the plurality of sites relative to the aggregated amount of resources available at the plurality of sites, respectively;
generate an interactive graphical user interface (GUI) comprising a map encompassing a geographical area in which the plurality of sites are located;
overlay the indicator on the GUI so as to identify the geographical area in which the plurality of sites are located; and
output the interactive GUI to a display device.
